(19) United States
(12) Patent Application Publication
(10) Pub. No.: US 2026/0096688 A1
(43) Pub. Date: Apr. 9, 2026

(54) BACONATOR PAN

(71) Applicant: MICHAEL VINCENT PISCITELLI, GENEVA, NY (US)

(72) Inventor: MICHAEL VINCENT PISCITELLI, GENEVA, NY (US)

(21) Appl. No.: 18/906,905

(22) Filed: Oct. 4, 2024

(51) Int. Cl. A47J 37/10; A47J 36/04; A47J 36/06

(52) U.S. Cl. CPC A47J 37/10; A47J 36/04; A47J 36/064

(57) ABSTRACT

The invention described here meets to solve the problem of removing grease from the everyday food being cooked, while ensuring even and quick cook times. The Baconator Pan is a everyday use pan with an elevated cooking surface, grease troth and cover that contains the food and grease. The pan lid created a small amount of pressure on the food and cooking surface to ensure a quicker, more even cook. This function also allows for the grease to be removed freely from the food being without needing to drain during the cooking process. Healthier, tastier finished foods can be served without having to ingest the grease absorbed during cooking. This is not something that currently exists and it improves on all flat pan designs by having an elevated cook surface and integrated troth to quickly remove any grease.

### BACKGROUND OF THE INVENTION

### Problem Solved

Grease free cooking of fatty meats via elevated cook surface and easy disposal of grease using built in troth and spout.

### DETAILED DESCRIPTION OF THE INVENTION

As stated above, the pan allows elevated cooking of greasy meats, removing it from the grease it produces while allowing that grease to be contained within a troth that has a spout of disposal.

As the meat cooks on the elevated portion of the pan the grease will drain down the sides of the pan into the troth. The lid covers the entire cooking and troth surface resulting in zero splash back.

The claimed invention is an improvement on what currently exists because there is nothing that has an elevated cooking surface so that the meats can be cooked grease free on a stovetop.

### The Version of the Invention Discussed Here Includes

1. Concave bottom, 12″ round, grease troth 2″×2″ deep, with side handles and grease spout
2. Lid fits over cooking surface to produce contact and create gap on sides for toth, eliminating splash back

### Relationship Between the Components

The pans shape allows for the troth to be created by using lid specifically made to create contact and pressure on meat being cooked and force grease into troth. The lid is designed to cover the troth in the pan and seal as any normal pan would.

### How the Invention Works

The pans bottom can either be heated directly by flame to produce the necessary cooking temperature on surface, or by electric cooktops with the understanding that cook times will vary.

The grease from the meat being cooked falls via gravity into the troth

The lid creates pressure on the meat to provide an even cooking as well as force extra grease from the meat.

The grease troth can be emptied by the spout on the side of the pan.

### How to Make the Invention

Press out one sheet of heat index material to an open bottom pan design. To create the grease troth the pan should then be shaped to allow for the 2×2″ section around the perimeter of the concave cooking surface.

Press out one sheet of same material to cover the pan

Rivet on (2) handles on base pan and (1) handle on lid.

### How to Use the Invention

Apply the pan to the stove and allow the unit to get hot. Apply desired meat to elevated surface and cover with the lid. Allow the meat to cook and grease to drain into troth. Remove lid to flip/remove meat. Use grease spout on pan for easy grease removal.

### Patent Search

20240306848-A1—Sep. 17, 2024—ZHANG, JIULAL
20240298835-A1—Sep. 19, 2024—KE WANG
20240108171-A1—Apr. 4, 2024—EDMUND A. STANCZAK
20230292956-A1—Sep. 21, 2023—GAZKICK, III, DONALD STEPHEN ET AL
20170071406-A1—Mar. 16, 2017—HUNTER JAMES J.

### DESCRIPTION OF DRAWINGS

FIG. 1 is a side profile view of the pan, lid, and grease spout

FIG. 2 is a side profile view of the pan, lid, and grease spout. This shows dotted lines where rounded edges allow for grease to drain to troth

FIG. 3 is a side profile view of the pan without the lid showing the raised cook surface. This also shows dotted lines where rounded edged allow for grease to drain into troth

FIG. 4 is an aerial view of the pan without the lid showing the elevated cook surface outline and dotted lines showing rounded edges for grease to drain into troth

FIG. 5 is an aerial view of the pan with lid.

FIG. 6 is the profile from beneath the pan.

FIG. 7 is an aerial view of the pan lid that covers the meat and grease troth

FIG. 8 is the profile from beneath the lid

FIG. 9 is a side profile view of the pan lid showing it's depth for both covering the meat and grease troth

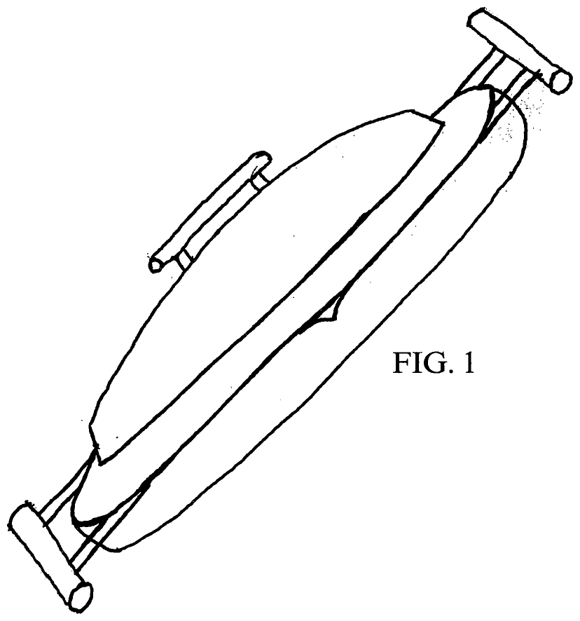

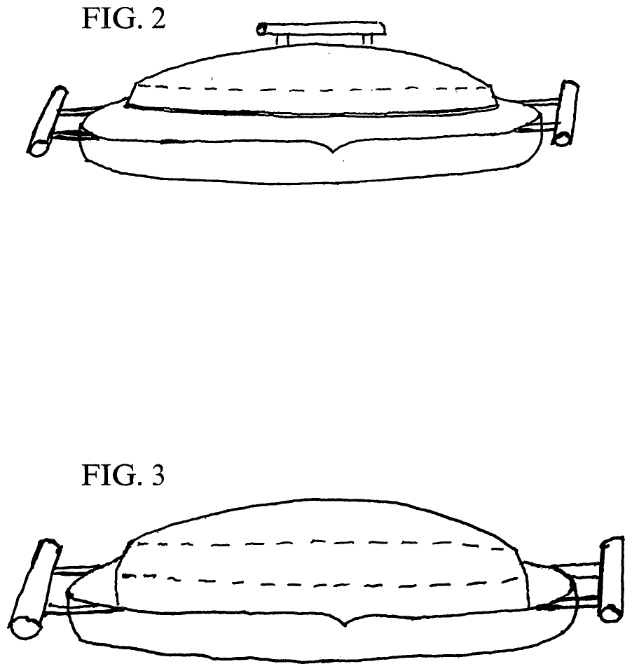

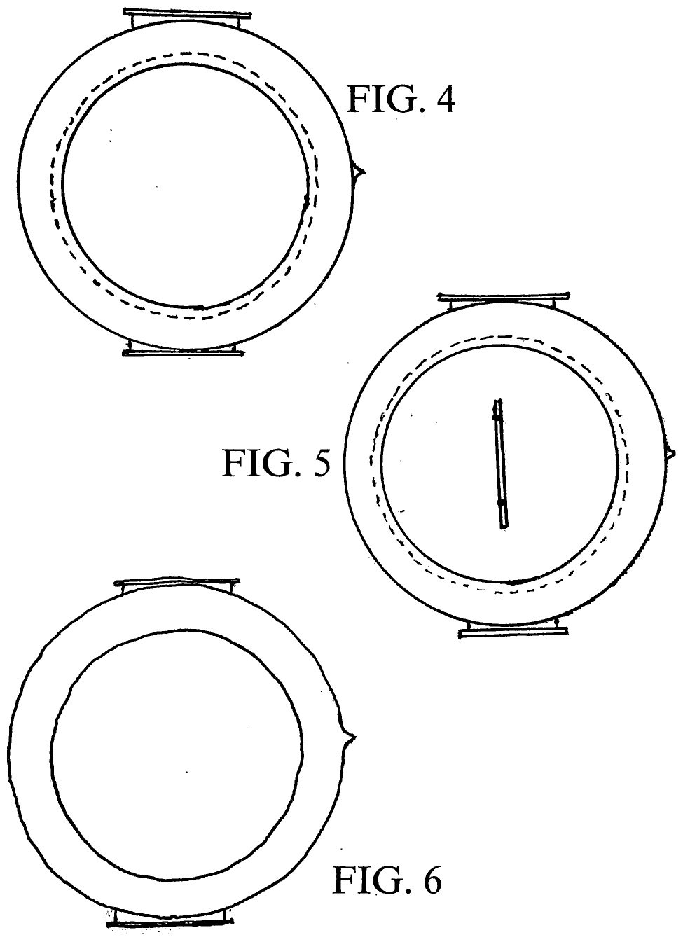

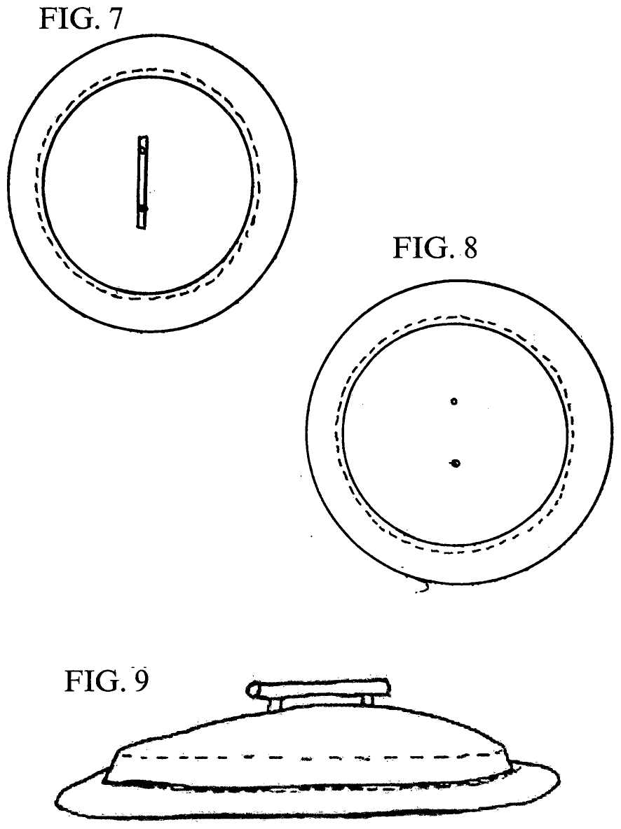

1: THIS IS A FUNCTIONAL DESIGN FOR A HOUSEHOLD PAN & LID THAT HAS A ELEVATED COOK SURFACE COVERED GREASE TROTH.

2: THE ELEVATED COOKING SURFACE ENSURES THE GREASE DRAINS FROM THE FOOD INTO THE COVERED TROTH VIA GRAVITY WHILE EVENLY COOKING THE FOOD.

3: THE COVERED GREASE TROTH (MADE OF HEAT-RESISTANT SILICONE) PREVENTS ALL GREASE SPLATTER.
